(19) United States
(12) Patent Application Publication
(10) Pub. No.: US 2019/0058924 A1
(43) Pub. Date: Feb. 21, 2019

(54) Displaying Enrichment Data Depending on Ad Time

(71) Applicant: COMIGO LTD., Yarkona (IL)

(72) Inventor: Menahem LASSER, Kohav-Yair (IL)

(21) Appl. No.: 16/053,106

(22) Filed: Aug. 2, 2018

Related U.S. Application Data
(60) Provisional application No. 62/545,541, filed on Aug. 15, 2017.

(51) Int. Cl. H04N 21/81; H04N 21/845; H04N 21/234; H04N 21/235

(52) U.S. Cl. CPC H04N 21/812; H04N 21/235; H04N 21/23424; H04N 21/8456

(57) ABSTRACT

Methods and systems are disclosed for presenting, on a user's screen, enrichment data related to video content items, wherein during a first time interval first visual enrichment data related to non-commercial video content of a video content item is displayed in a first visual mode simultaneously with the displaying of the video content item, and during a second time interval second visual enrichment data related to the non-commercial video content is be displayed in a second visual mode simultaneously with the displaying of commercial content of the video content item. The first visual enrichment data and the second visual enrichment data is of the same type of enrichment data, the second visual mode is different from the first visual mode, and a portion of the first visual enrichment data and a portion of the second visual enrichment data convey the same information.

### CROSS-REFERENCE TO RELATED APPLICATIONS

This patent application claims the benefit of U.S. Provisional Patent Application No. 62/545,541 filed on Aug. 15, 2017, which is incorporated herein by reference in its entirety.

### FIELD OF THE INVENTION

The present invention relates to systems and methods for presenting visual enrichment data on a user's screen together with video content items. In particular, the present invention relates to presenting enrichment data with video content items that include both commercial and non-commercial video content.

### BACKGROUND

When TV technology first became commercially available to the public, users could only consume video content at their homes under fixed pre-determined schedules and in a linear way. That is—a user could only watch a movie or a news program at the time a broadcaster decided to broadcast it, and no deviation from the pre-defined program guide was possible. The only flexibility a user had was the selection of which channel to display on one's TV screen, thus selecting between multiple video content items that are currently aired.

At a later stage Video-On-Demand (VOD) was offered to the users. This service enabled them to consume content not appearing on the current programs schedule, and resulted in a significant increase in flexibility when deciding what to watch. Another boost in user flexibility was achieved when TV operators Introduced Catch-Up TV services which not only allow a user to pick any program recently offered in the EPG (Electronic Program Guide), but also allows him to jump backward and forward in time within a specific program and to freeze and resume the playing of a program.

The next step in the process of increasing user flexibility was reached when some advanced Set-Top Boxes (STBs) started offering means to a user for asking for enrichment data for a video content item he is currently watching. Enrichment data may be sport statistics related to a game currently watched by the requesting user, a picture of a person whose name is mentioned in the audio channel of the currently watched video content item (e.g. during a news program), textual information related to a person seen in the visual channel of the currently watched video content item, a list of links to related video content items that are related to the currently watched video content item (from which list the user may select an item he wants to watch), a list of the main actors appearing in the currently watched video content item accompanied by their pictures and/or biographies, etc.

When a user indicates his desire to get enrichment data for the currently watched video content item, for example by pressing a button on a remote controller device or by selecting a button on the screen using a pointing device, the enrichment data (or the list of options for enrichment data) is displayed on the screen. The user's request may explicitly indicate the type of enrichment data he is interested in (for example, using a button dedicated to asking for sport stats). Alternatively, the request may be generic or partially-generic (for example, the user is asking for any available enrichment data or for any available enrichment data that is related to the actors of the currently watched video content item), and the system then displays links to multiple enrichment items, letting the user choose his desired enrichment item from the list.

When displaying enrichment data related to the currently watched video content item, the enrichment data is typically displayed on top of the watched content, which continues to be played in the background. This causes a disturbance in watching the main content, as the enrichment data might hide important elements of it. Attempting to avoid this type of disturbance by displaying the enrichment data side-by-side with the watched content causes reducing the screen area allocated to the watched content, which is also a disturbance to the user's viewing experience.

For example, if the watched content is a basketball game, the user may ask to display the scoring statistics of all ten players currently in the game. If the system is designed to display its enrichment data (including its sport stats) in the left side of the screen, then the stats table might hide one of the baskets, which is a main point of interest for the user. Similarly, if the watched content is a boxing match, the user may ask to display the historical scores of the two fighters. If the system is designed to display its enrichment data (including its historical scores) in the center of the screen, then the scores table might hide the center of the ring, which is a main point of interest during much of the fight. Therefore, we conclude that there is no area in the screen which is a safe location in which enrichment data can be displayed without risking disturbing the user's viewing of the main content.

U.S. Pat. No. 9,432,722 discloses methods for minimizing interference between a graphic overlay and background content over which it is displayed. The disclosed methods operate by dynamically changing one or more attributes of the overlay when the overlay is located over a point of interest in the background content, so that the visual disturbance caused to the point of interest in the background content is minimized, where the attributes of the overlay that are being changed may be color, transparency, size and shape. Similarly, U.S. Pat. No. 8,451,380 and US Patent Publication 2011/0188836 also disclose methods for minimizing interference between a graphic overlay and background content over which it is displayed, which operate by dynamically changing the location of the overlay, so that visual disturbance caused to points of interest in the background content is minimized. However, all these methods require determination of the dynamic shifting of points of interest in the background content. Such determination is a heavy task that requires much processing power, and therefore is not practical in many systems.

Therefore, it is desirable to find a simple way to provide a user with a way to view enrichment data for his viewed content, while minimizing the disturbance to the user's content viewing experience.

### SUMMARY

A method is disclosed, according to embodiments, for presenting, on a user's screen, enrichment data related to a video content item, wherein the video content item includes non-commercial video content and commercial video content. The method comprises causing the video content item to be displayed on the screen, and while the video content item is displayed, (i) during a first time interval throughout which the displaying of the video content item includes displaying non-commercial video content, causing first visual enrichment data related to the non-commercial video content of the video content item to be displayed simultaneously with the displaying of the video content item, and (ii) during a second time interval that is adjacent to the first time interval, throughout which second time interval the displaying of the video content item consists of displaying commercial video content, causing second visual enrichment data related to the non-commercial video content of the video content item to be displayed simultaneously with the displaying of the video content item. The method also comprises in response to an event that is a member of the event group consisting of (i) ending the first time interval and starting the second time interval and (ii) ending the second time interval and starting the first time interval, changing a visual mode used for displaying visual enrichment data from a first visual mode to a second visual mode, the first visual mode being different from the second visual mode. A portion of the first visual enrichment data and a portion of the second visual enrichment data convey the same information, and the first visual enrichment data and the second visual enrichment data are of a same type of enrichment data, where the type of enrichment data is selected from the group consisting of text, animation, video clip, still picture and any combination of them.

In some embodiments, the second visual enrichment data and the commercial video content can be displayed simultaneously, without either one obscuring any portion of the other, during at least a portion of the second time interval. In some embodiments, the second visual enrichment data can be displayed at least partly superimposed over the commercial video content during at least a portion of the second time interval.

In some embodiments, the portion of the first visual enrichment data and the portion of the second visual enrichment data can be displayed so that they differ in at least one visual characteristic. In some embodiments, the portion of the first visual enrichment data and the portion of the second visual enrichment data can be displayed on the screen in different sizes. In some embodiments, the portion of the first visual enrichment data and the portion of the second visual enrichment data can be displayed on the screen in different levels of detail. In some embodiments, the portion of the first visual enrichment data and the portion of the second visual enrichment data can be displayed on the screen in different levels of transparency. In some embodiments, the portion of the first visual enrichment data and the portion of the second visual enrichment data can be displayed on the screen in different colors. In some embodiments, the portion of the first visual enrichment data and the portion of the second visual enrichment data can be displayed in different locations on the screen.

In some embodiments, it can be that the portion of the first visual enrichment data and the portion of the second visual enrichment data contain text in the same language, and the text in the portion of the first visual enrichment data and the text in the portion of the second visual enrichment data are displayed on the screen in different fonts. In some of these embodiments, the different fonts can differ in at least one attribute selected from the group consisting of font family, font style and font size.

A method is disclosed, according to embodiments, for presenting, on a user's screen, enrichment data related to a video content item, wherein the video content item includes non-commercial video content and commercial video content. The method comprises causing the video content item to be displayed on the screen, and, while the video content item is displayed, (i) during a first time interval throughout which the displaying of the video content item includes displaying non-commercial video content, causing first visual enrichment data related to the non-commercial video content of the video content item to be displayed in a first visual mode simultaneously with the displaying of the video content item, and (ii) during a second time interval that does not overlap any portion of the first time interval, throughout which second time interval the displaying of the video content item consists of displaying commercial video content, causing second visual enrichment data related to the non-commercial video content of the video content item to be displayed in a second visual mode simultaneously with the displaying of the video content item. The first visual enrichment data and the second visual enrichment data are of a same type of enrichment data, where the type of enrichment data is selected from the group consisting of text, animation, video clip, still picture and any combination of them; the second visual mode is different from the first visual mode; and a portion of the first visual enrichment data and a portion of the second visual enrichment data convey the same information.

In some embodiments, the second visual enrichment data and the commercial video content can be displayed simultaneously, without either one obscuring any portion of the other, during at least a portion of the second time interval. In some embodiments, the second visual enrichment data can be displayed at least partly superimposed over the commercial video content during at least a portion of the second time interval.

In some embodiments, it can be that (i) the second time interval immediately follows the first time interval, (ii) the displaying of the first visual enrichment data in the first visual mode ends at the beginning of the second time interval, and (iii) the displaying of the second visual enrichment data in the second visual mode starts at the beginning of the second time interval. In some embodiments, it can be that (i) the first time interval immediately follows the second time interval, (ii) the displaying of the second visual enrichment data in the second visual mode ends at the beginning of the first time interval, and (iii) the displaying of the first visual enrichment data in the first visual mode starts at the beginning of the first time interval.

In some embodiments, the portion of the first visual enrichment data and the portion of the second visual enrichment data are displayed so that they differ in at least one visual characteristic. In some embodiments, the portion of the first visual enrichment data and the portion of the second visual enrichment data can be displayed on the screen in different sizes. In some embodiments, the portion of the first visual enrichment data and the portion of the second visual enrichment data can be displayed on the screen in different levels of detail. In some embodiments, the portion of the first visual enrichment data and the portion of the second visual enrichment data can be displayed on the screen in different levels of transparency. In some embodiments, the portion of the first visual enrichment data and the portion of the second visual enrichment data can be displayed on the screen in different colors. In some embodiments, the portion of the first visual enrichment data and the portion of the second visual enrichment data can be displayed in different locations on the screen.

In some embodiments, it can be that the portion of the first visual enrichment data and the portion of the second visual enrichment data contain text in the same language, and the text in the portion of the first visual enrichment data and the text in the portion of the second visual enrichment data are displayed on the screen in different fonts. In some of these embodiments, the different fonts can differ in at least one attribute selected from the group consisting of font family, font style and font size.

A method is disclosed, according to embodiments, for presenting, on a user's screen, enrichment data related to video content items, wherein each video content item includes non-commercial video content and commercial video content. The method comprises causing a first video content item to be displayed on the screen, and while the first video content item is displayed and during a first time interval throughout which the displaying of the first video content item includes displaying non-commercial video content, causing first visual enrichment data related to the non-commercial video content of the first video content item to be displayed in a first visual mode simultaneously with the displaying of the first video content item. The method also comprises causing a second video content item to be displayed on the screen, and, while the second video content item is displayed and during a second time interval that does not overlap any portion of the first time interval, throughout which second time interval the displaying of the second video content item consists of displaying commercial video content, causing second visual enrichment data related to the non-commercial video content of the second video content item to be displayed simultaneously with the displaying of the second video content item. The first visual enrichment data and the second visual enrichment data are of a same type of enrichment data, where the type of enrichment data is selected from the group consisting of text, animation, video clip, still picture and any combination of them, and the second visual mode is different from the first visual mode.

In some embodiments, the second visual enrichment data and the commercial video content of the second video content item can be displayed simultaneously, without either one obscuring any portion of the other, during at least a portion of the second time interval. In some embodiments, the second visual enrichment data can be displayed at least partly superimposed over the commercial video content of the second video content item during at least a portion of the second time interval.

In some embodiments, a portion of the first visual enrichment data and a portion of the second visual enrichment data can convey the same information. In some embodiments, the first video content item and the second video content item can be the same video content item.

In some embodiments, the portion of the first visual enrichment data and the portion of the second visual enrichment data can be displayed so that they differ in at least one visual characteristic. In some embodiments, the portion of the first visual enrichment data and the portion of the second visual enrichment data can be displayed on the screen in different sizes. In some embodiments, the portion of the first visual enrichment data and the portion of the second visual enrichment data can be displayed on the screen in different levels of detail. In some embodiments, the portion of the first visual enrichment data and the portion of the second visual enrichment data can be displayed on the screen in different levels of transparency. In some embodiments, the portion of the first visual enrichment data and the portion of the second visual enrichment data can be displayed on the screen in different colors. In some embodiments, the portion of the first visual enrichment data and the portion of the second visual enrichment data can be displayed in different locations on the screen.

In some embodiments, it can be that the portion of the first visual enrichment data and the portion of the second visual enrichment data contain text in the same language, and the text in the portion of the first visual enrichment data and the text in the portion of the second visual enrichment data are displayed on the screen in different fonts. In some of these embodiments, the different fonts can differ in at least one attribute selected from the group consisting of font family, font style and font size.

In embodiments, a system for distributing video content comprises a video-content-item distribution module, a visual-enrichment-data distribution module, one or more computer processors and a non-transitory computer-readable storage medium storing program instructions for execution by the one or more computer processors, the non-transitory computer-readable storage medium having stored therein: (i) first program instructions, that when executed by the one or more processors cause the video-content-item distribution module to cause the displaying, on a user's screen, of a video content item that includes non-commercial video content and commercial video content; and (ii) second program instructions, that when executed by the one or more processors, cause the visual-enrichment-data distribution module to cause: (A) the displaying, on the user's screen, of first visual enrichment data related to the non-commercial video content of the video content item simultaneously with the displaying of the video content item, the simultaneous displaying of the first visual enrichment data and the video content item occurring during a first time interval throughout which the displaying of the video content item includes displaying non-commercial video content; and (B) the displaying, on the user's screen, of second visual enrichment data related to the non-commercial video content of the video content item simultaneously with the displaying of the video content item, the simultaneous displaying of the second visual enrichment data and the video content item occurring during a second time interval that is adjacent to the first time interval, throughout which second time interval the displaying of the video content item consists of displaying commercial video content, wherein (I) a portion of the first visual enrichment data and a portion of the second visual enrichment data convey the same information, and (II) the first visual enrichment data and the second visual enrichment data are of a same type of enrichment data, where the type of enrichment data is selected from the group consisting of text, animation, video clip, still picture and any combination of them. The non-transitory computer-readable storage medium additionally has stored therein third program instructions, that when executed by the one or more processors, cause the changing of a visual mode used for displaying visual enrichment data from a first visual mode to a second visual mode, the first visual mode being different from the second visual mode, in response to an event that is a member of the event group consisting of (A) ending the first time interval and starting the second time interval and (B) ending the second time interval and starting the first time interval.

In embodiments, a system for distributing video content comprises a video-content-item distribution module, a visual-enrichment-data distribution module, one or more computer processors, and a non-transitory computer-readable storage medium storing program instructions for execution by the one or more computer processors, the non-transitory computer-readable storage medium having stored therein: (i) first program instructions, that when executed by the one or more processors cause the video-content-item distribution module to cause the displaying, on a user's screen, of a video content item that includes non-commercial video content and commercial video content; and (ii) second program instructions, that when executed by the one or more processors, cause the visual-enrichment-data distribution module to cause: (A) first visual enrichment data related to the non-commercial video content of the video content item to be displayed in a first visual mode simultaneously with the displaying of the video content item, the simultaneous displaying of the first visual enrichment data and the video content item occurring during a first time interval throughout which the displaying of the video content item includes displaying non-commercial video content, and (B) second visual enrichment data related to the non-commercial video content of the video content item to be displayed in a second visual mode simultaneously with the displaying of the video content item, the simultaneous displaying of the second visual enrichment data and the video content item occurring during a second time interval that does not overlap any portion of the first time interval, throughout which second time interval the displaying of the video content item consists of displaying commercial content, wherein (I) the first visual enrichment data and the second visual enrichment data are of a same type of enrichment data, where the type of enrichment data is selected from the group consisting of text, animation, video clip, still picture and any combination of them, (II) the second visual mode is different from the first visual mode, and (III) a portion of the first visual enrichment data and a portion of the second visual enrichment data convey the same information.

In embodiments, a system for distributing video content comprises a video-content-item distribution module, a visual-enrichment-data distribution module, one or more computer processors, and a non-transitory computer-readable storage medium storing program instructions for execution by the one or more computer processors, the non-transitory computer-readable storage medium having stored therein: (i) first program instructions, that when executed by the one or more processors cause the video-content-item distribution module to cause the displaying, on a user's screen, of a first video content item that includes non-commercial video content and commercial video content; (ii) second program instructions, that when executed by the one or more processors, cause the visual-enrichment-data distribution module to cause first visual enrichment data related to the non-commercial video content of the first video content item to be displayed in a first visual mode simultaneously with the displaying of the first video content item, the simultaneous displaying of the first visual enrichment data and the first video content item occurring during a first time interval throughout which the displaying of the first video content item includes displaying non-commercial video content; (iii) third program instructions, that when executed by the one or more processors cause the video-content-item distribution module to cause the displaying, on a user's screen, of a second video content item that includes non-commercial video content and commercial video content; and (iv) fourth program instructions, that when executed by the one or more processors, cause the visual-enrichment-data distribution module to cause second visual enrichment data related to the non-commercial video content of the second video content item to be displayed simultaneously with the displaying of the second video content item, the simultaneous displaying of the second visual enrichment data and the second video content item occurring during a second time interval that does not overlap any portion of the first time interval, throughout which second time interval the displaying of the second video content item consists of displaying commercial content, wherein (A) the first visual enrichment data and the second visual enrichment data are of a same type of enrichment data, where the type of enrichment data is selected from the group consisting of text, animation, video clip, still picture and any combination of them, and (B) the second visual mode is different from the first visual mode.

### BRIEF DESCRIPTION OF THE DRAWINGS

FIG. 1 is a schematic illustration of a system for distributing content, causing the displaying of a video content item, and first and second visual enrichment data, on a user's screen, according to embodiments.

FIG. 2 is a schematic illustration of a system for distributing content, causing the displaying of first and second video content items, and first and second visual enrichment data, on a user's screen, according to embodiments.

FIGS. 3A and 3B are schematic illustrations of two non-overlapping time intervals according to embodiments.

FIGS. 4A, 4B, 4C and 4D are schematic illustrations of a user's screen displaying non-commercial and commercial content of a video content item, together with first or second visual enrichment data during respective first or second time intervals, according to embodiments.

FIG. 5 is a schematic illustration of first and second visual enrichment data where a portion of the first conveys the same information as a portion of the second.

FIGS. 6A and 6B are schematic illustrations of a user's screen displaying non-commercial content of a first video content item together with first visual enrichment data during a first time interval, and displaying commercial content of a second video content item together with second visual enrichment data during a second time interval, according to embodiments.

FIGS. 7, 8 and 9 show schematic representations of computer-readable storage media and groups of program instructions stored thereon, according to some embodiments.

FIGS. 10, 11 and 12 show flowcharts of methods for presenting, on a user's screen, enrichment data related to one or more video content items that each include non-commercial video content and commercial video content.

### DETAILED DESCRIPTION OF THE EMBODIMENTS

Note: Throughout this disclosure, subscripted reference numbers (e.g., 10₁) may be used to designate multiple separate appearances of elements in a single drawing, e.g. 10₁ is a single appearance (out of a plurality of appearances) of element 10. The same elements can alternatively be referred to without subscript (e.g., 10 and not 10₁) when not referring to a specific one of the multiple separate appearances.

The disclosed embodiments take advantage of the fact that content providers and operators insert commercial ads within programs and movies. Most users do not mind so much disturbances occurring while a commercial is being played, and are clearly much more tolerant to commercial-time disturbances than to similar true-content-time disturbances. The proposed solution provides an “incentive” to users to prefer asking for enrichment data during commercial time, rather than during non-commercial time. This is done by displaying the enrichment data in different ways during the time a commercial is being shown and during the time “true content” is being shown, where the change in the enrichment data viewing mode when commercials are being shown is such that users should find it more appealing to ask for the enrichment data during commercial time.

Methods for identifying when commercials are being shown are well known in the art, and any method for achieving this task may be used in implementing the proposed solution. Examples for such methods can be found in U.S. Pat. No. 6,100,941, U.S. Pat. No. 7,170,566, U.S. Pat. No. 6,285,818, U.S. Pat. No. 7,110,658, and US Application No. 2003/0123841, which are all incorporated herein by reference in their entirety.

In a first embodiment, when enrichment data is displayed during true content time, it is displayed in a form that is less intrusive to what is shown on the screen, but is more difficult and less convenient for watching and reading the enrichment data. When enrichment data is displayed during commercials, it is displayed in a form that is less difficult and more convenient for watching and reading the enrichment data, even though it might be more intrusive to what is shown on the screen.

The logic behind this embodiment is that a user interested in enrichment data would prefer to see it presented to him in the clearest and most convenient way. Because enrichment data shown during commercial time is displayed in a clearer and more convenient way than enrichment data shown during true content time, the user has motivation to postpone his request for enrichment data until the next commercial. At the same time, the disturbance caused to true content when displaying enrichment data over it is reduced. Consequently, the amount of time enrichment data is displayed over true content and disturbs it is reduced, the level of disturbance to true content when enrichment data is displayed over it is also reduced, and both factors contribute to improving the user's overall content viewing experience.

Examples of how enrichment data is displayed in different forms (i.e. in different visual modes) when shown during commercials and during true content are:

Changing the size of the displayed enrichment data. When displayed over a commercial the enrichment data is shown in a first size, while when displayed over true content the same enrichment data is shown in a second size, which is smaller than the first size. Thus, when enrichment data is watched over true content, its smaller size reduces the disturbance it would otherwise cause. On the other hand, when enrichment data is watched over commercials, its larger size makes it easier to watch and read.

Changing the level of detail of the displayed enrichment data. When displayed over a commercial the enrichment data is shown with a first level of detail, while when displayed over true content the same enrichment data is shown with a second level of detail, which is lower than the first level of detail. Thus, when enrichment data is watched over true content, its lower level of detail reduces the disturbance it would otherwise cause. On the other hand, when enrichment data is watched over commercials, its higher level of detail makes it more useful to the user.

Changing the transparency of the displayed enrichment data. When displayed over a commercial the enrichment data is shown with a first level of transparency, while when displayed over true content the same enrichment data is shown with a second level of transparency, which is higher than the first level of transparency. Thus, when enrichment data is watched over true content, its higher level of transparency reduces the disturbance it would otherwise cause. On the other hand, when enrichment data is watched over commercials, its lower level of transparency makes it easier to watch and read.

Changing the color of the displayed enrichment data. When displayed over a commercial the enrichment data is shown in a first color, while when displayed over true content the same enrichment data is shown in a second color, which provides weaker contrast with the background than the first color. Thus, when enrichment data is watched over true content, its weaker level of contrast reduces the disturbance it would otherwise cause. On the other hand, when enrichment data is watched over commercials, its stronger level of contrast makes it easier to watch and read.

Changing the screen location of the displayed enrichment data. When displayed over a commercial the enrichment data is shown in a first screen location, while when displayed over true content the same enrichment data is shown in a second screen location, which provides lower level of interference with the background than the first screen location. Thus, when enrichment data is watched over true content, its lower level of interference reduces the disturbance it would otherwise cause. On the other hand, when enrichment data is watched over commercials, its higher level of interference makes it easier to watch and read. An example of controlling the level of interference with the background by changing the screen location of the enrichment data is displaying the enrichment data over true content at an edge of the screen, while displaying the enrichment data over a commercial at the center of the screen.

Changing the font of text that appears in the displayed enrichment data. When displayed over a commercial the enrichment data is shown with a first font, while when displayed over true content the same enrichment data is shown with a second font, which is more difficult to read than the first font but causes less disturbance to the background content. Thus, when enrichment data is watched over true content, its more difficult-to-read font reduces the disturbance it would otherwise cause. On the other hand, when enrichment data is watched over commercials, its easier-to-read font makes it easier to watch and read. Examples of controlling the level of interference with the background by changing the font used in displaying the enrichment data are displaying the enrichment data over true content using a difficult-to-read font family (e.g. BN Witch), a difficult-to-read font style (e.g. italics style) or a difficult-to-read font size (e.g. size 9), while displaying the enrichment data over a commercial using an easy-to-read font (e.g. Calibri), easy-to-read font style (e.g. bold style) or easy-to-read font size (e.g. size 14).

In a second embodiment, when enrichment data is displayed during a commercial, the window in which the content is displayed is shrunken compared to its normal size (which is typically full-screen), and the enrichment data and the content are shown side by side on the same screen. When enrichment data is displayed during true content, the content is shown normally (typically full-screen) and the enrichment data is displayed on top of it.

The logic behind this embodiment is analogous to that of the first embodiment. When enrichment data is watched during true content, the larger size of the content window makes the content easier to watch. On the other hand, when enrichment data is watched during commercials, the side-by-side display eliminates interference with the content and makes it easier to watch and read the enrichment data.

Even though users typically do not care about disturbing commercials, advertisers (and consequently operators that must keep advertisers happy) do care about disturbing commercials. Therefore, one might argue that the proposed solution might face objection from operators, which objection might block the use of the solution.

However, this is not the case, because the proposed solution actually serves the interests of the advertisers, making it a win-win solution. This is so because the major fear of an advertiser is that when its commercial starts playing users will either switch to another channel or spend the commercial's playing time away from the screen (for example in the restrooms). In both cases the user does not watch the commercial and is not affected by it. But when displaying visual enrichment data according to the disclosed embodiments, the user is motivated to make use of a commercial's playing time for watching enrichment data related to the watched content. While watching the enrichment data, the user stays both at the screen and in the current channel, and therefore watches the commercial ad. It is preferable for the advertiser that the user will look at the screen during the commercial, even if the commercial is somewhat disturbed or reduced in size because of the enrichment data.

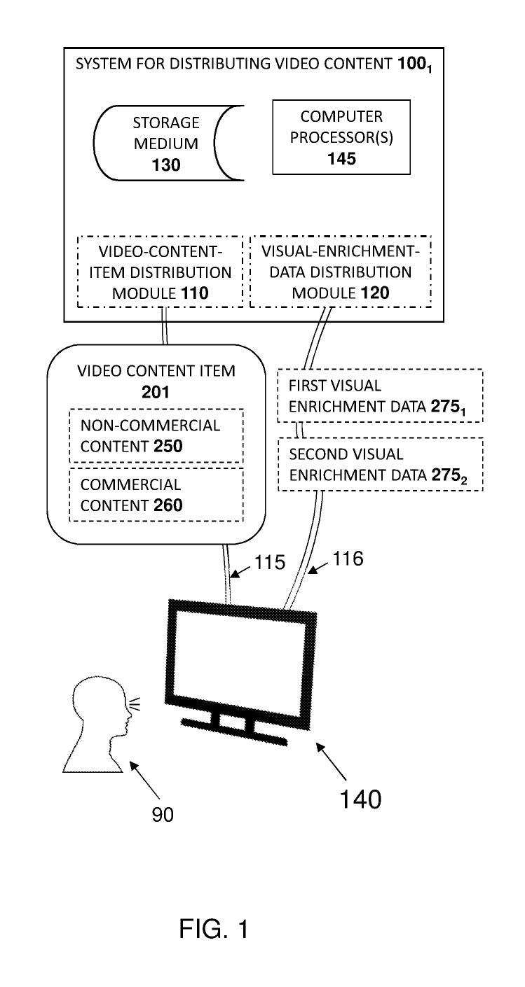

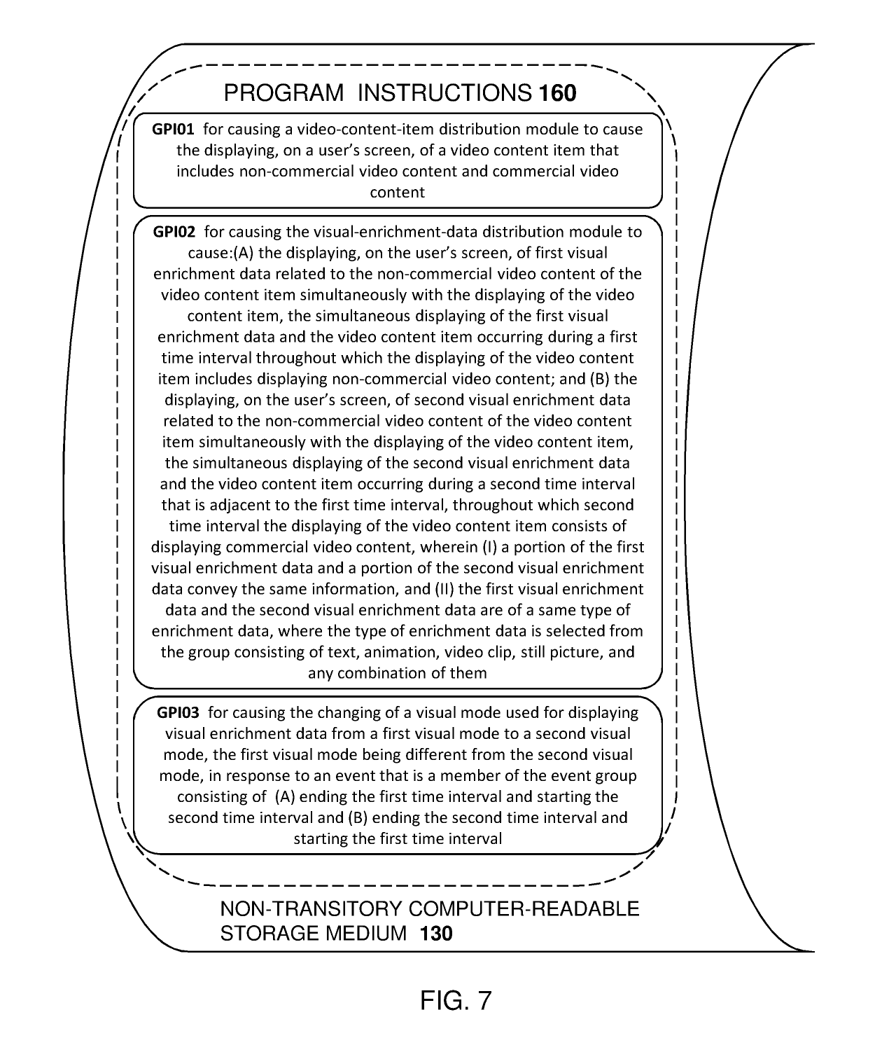

Referring now to the figures, and in particular to FIG. 1, a first system 100₁ for distributing video content is illustrated, where the system 100₁ comprises a video-content-item distribution module 110, a visual-enrichment-data distribution module 120; one or more computer processors 145, and a non-transitory computer-readable storage medium 130 storing program instructions 160. Examples of stored program instructions 160 are shown in FIGS. 7-9 and discussed later in this disclosure. Both the video-content-item distribution module 110 and the visual-enrichment-data distribution module 120 are in at least indirect communication via respective communications channels 115, 116 with a display screen 140 of a user 90. Communications channels 115, 116 can include any communications technology known in the art for delivering video content and related content, whether wired or wireless or both, and including, but not exhaustively, over-the-air broadcast television systems, cable television systems, over-the-Internet television systems (e.g. IPTV or OTT), and satellite televisions systems. Video-content-item distribution module 110 is operable to deliver a video content item 201, for example according to a schedule or on-demand, to the user's display screen 140. The expression “deliver to the screen 140” as used herein or any conjugate thereof means that that the video content item 201 is caused to be displayed on the screen 140. A video content item 201 can include non-commercial content 250 and commercial content 260. Visual-enrichment-data distribution module 120 is operable to deliver first and second visual enrichment data 275₁, 275₂ to the user's display screen 140, for example upon user request as described earlier in this disclosure. In some embodiments, both first and second visual enrichment data 275₁, 275₂ are related to the non-commercial content 250 of video content item 201; first visual enrichment data 275₁ is displayed while non-commercial content 250 is playing, i.e., simultaneously with the non-commercial content 250, whereas second visual enrichment data 275₂ is displayed while commercial content 260 is playing, i.e., simultaneously with the commercial content 260.

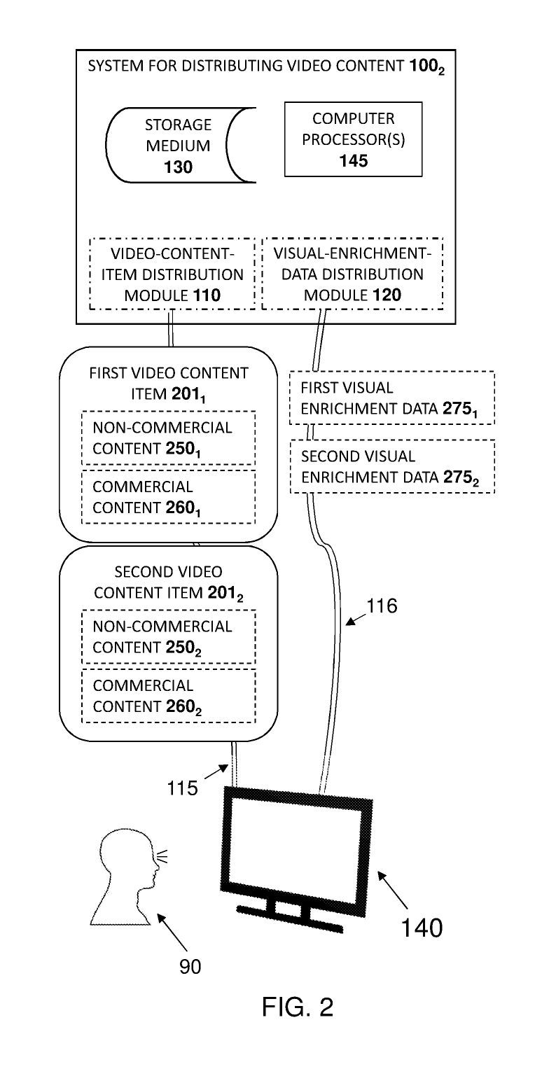

FIG. 2 illustrates another system 100₂ for distributing video content, similar to the one shown in FIG. 1, but one that relates to the video-content-item distribution module being operable to deliver multiple video content items to the user's screen 140, specifically, in the non-limiting example illustrated, first video content item 201₁ that includes non-commercial content 250₁ and commercial content 260₁, and second video content item 201₂ that includes non-commercial content 250₂ and commercial content 260₂. In some embodiments, first visual enrichment data 275₁ is related to the non-commercial content 250₁ of first video content item 201₁ and second visual enrichment data 275₂ is related to the non-commercial content 250₂ of second video content item 201₂. First visual enrichment data 275₁ is displayed while non-commercial content 250₁ is playing, i.e., simultaneously with the non-commercial content 250₁, whereas second visual enrichment data 275₂ is displayed while commercial content 260₂ is playing, i.e., simultaneously with the commercial content 260₂.

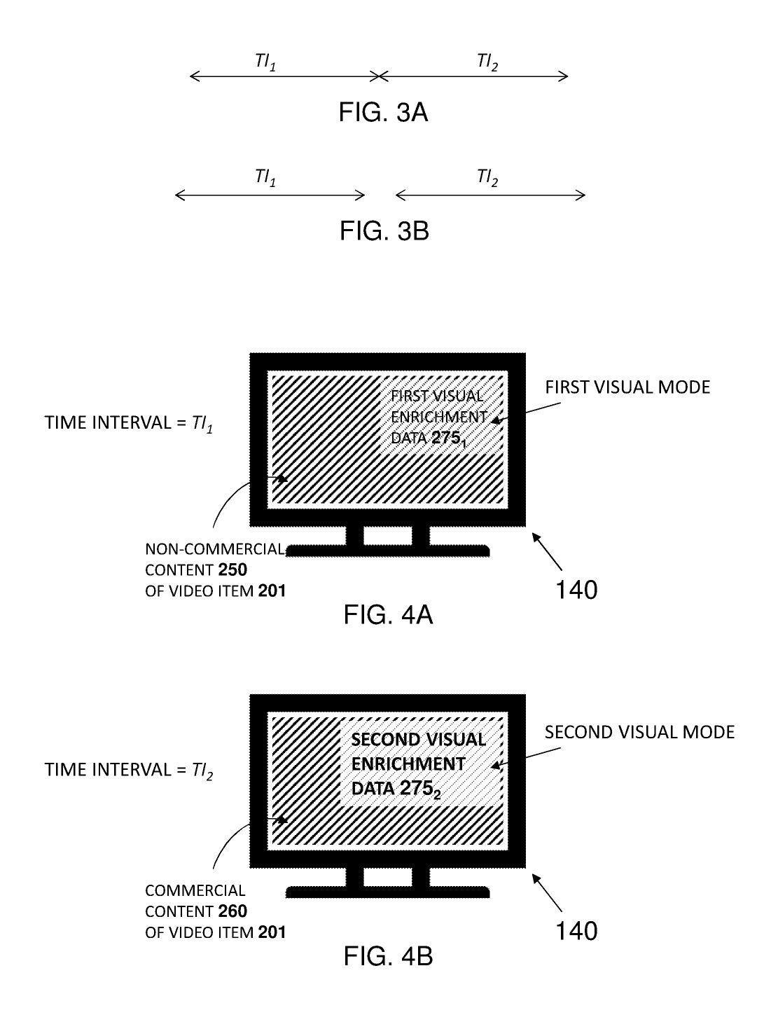

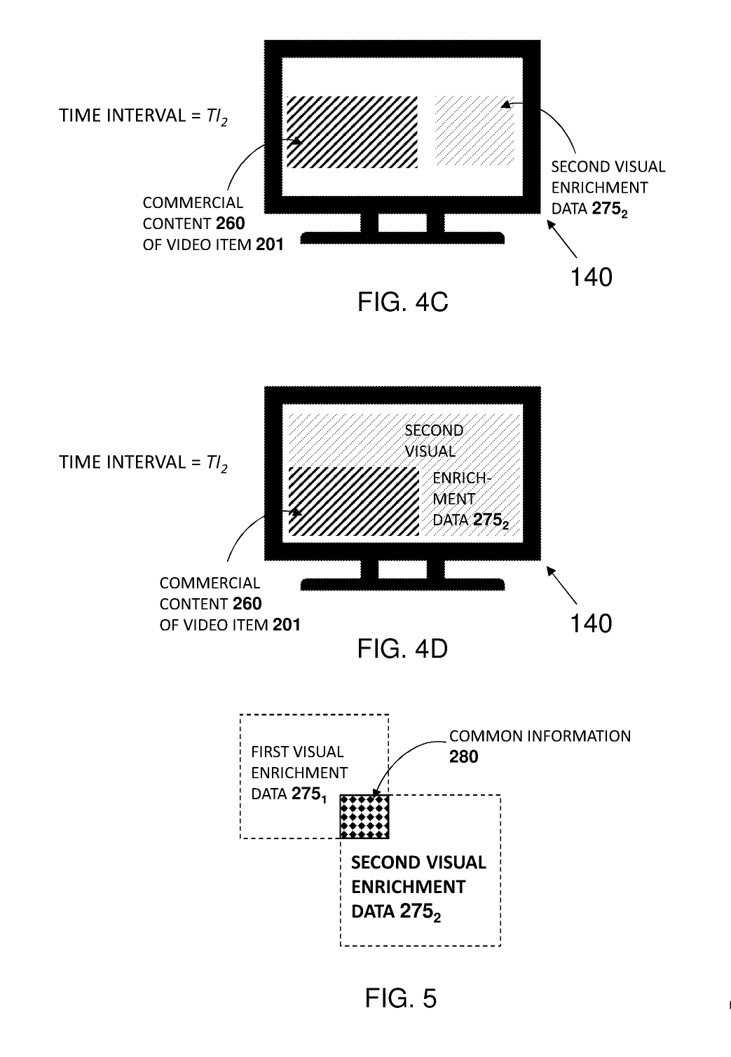

FIGS. 3A and 3B illustrate two time intervals TI₁, TI₂ that do not overlap. FIG. 3A shows an example of the two time intervals TI₁, TI₂ as being contiguous, one immediately following the other, while FIG. 3B shows an example of the two time intervals TI₁, TI₂ as being non-contiguous. FIG. 4A illustrates an embodiment related to the system 100₁ of FIG. 1, in which first visual enrichment data 275₁ related to the non-commercial content 250 of video content item 201, is displayed on screen 140 (of user 90) simultaneously with non-commercial content 250 of video content item 201, during first time interval TI₁. This simultaneous displaying can be followed, as shown in FIG. 4B, by the displaying during second time interval TI₂, of second visual enrichment data 275₂ simultaneously with the commercial content 260 of video content item 201, either:
(i) immediately after the displaying of first visual enrichment data 275₁ (of FIG. 4A) in first time interval TI₁, and without a gap in time. In an example, the first and second time intervals TI₁, TI₂ are contiguous as in FIG. 3A, the displaying of the first visual enhancement data 275₁ may end at the end of first time interval TI₁, and the displaying of second visual enhancement data 275₂ may begin at the start of second time interval TI₂, or
(ii) later, and with a gap in time. In a first example, the first and second time intervals TI₁, TI₂ are non-contiguous as in FIG. 3B. In a second example, the first and second time intervals TI₁, TI₂ are contiguous as in FIG. 3A but the displaying of the first visual enhancement data 275₁ may end before the end of first time interval TI₁, and/or the displaying of second visual enhancement data 275₂ may begin after the start of second time interval TI₂.

As shown in FIGS. 4A and 4B, first visual enrichment data 275₁ is displayed in a first visual mode during the first time interval TI₁, and second visual enhancement data 275₂ is displayed in a second visual mode during the second time interval TI₂. In the non-limiting example of FIG. 4B, the second visual mode is different from the first visual mode in that the font size is larger, the font face is bolder, and the background of the visual enhancement data 275 is more transparent, all in comparison with the first visual mode of FIG. 4A. In two additional non-limiting examples of displaying second visual enhancement data during a second time interval TI₂ that are illustrated in FIGS. 4C and 4D, the second visual enhancement data 275₂ is displayed ‘side-by-side’ with the commercial content 260 of first video content item 201, such that neither obscures the other. In the example of FIG. 4C, the second visual enhancement data 275₂ is literally ‘side-by-side’ with the commercial content 260, with the commercial content 260 shrunken in size so as to retain its original aspect ratio. The surface of the display screen 140 is not fully exploited. In the example of FIG. 4D, the second visual enhancement data 275₂, displayed in an “L”-shaped format, flanks the commercial content 260 on two sides; the commercial content 260 is again shown as shrunken in size so as to retain its original aspect ratio. In yet other examples, second visual enhancement data 275₂ can flank the commercial content 260 on three or even four sides. In all side-by-side cases, no portion of the commercial content 260 is cropped or obscured.

In some embodiments, first and second visual enrichment data 275₁, 275₂ may convey the same information, for example when they both include equivalent text and/or graphics that is displayed using different fonts, different colors, different sizes, etc. In other embodiments a portion of first visual enrichment data 275₁ may convey the same information as a portion of second visual enrichment data 275₂. As illustrated schematically in FIG. 5, common information 280 can be conveyed by a respective portion of each of first and second visual enrichment data 275₁, 275₂. For example, both the first and the second visual enrichment data may refer to the same subject, but differ in levels of detail. One of them may include only a summary or only headers, while the other one may include the summary or the headers plus additional details. In such case, the common information is the summary or the headers, where the common information is equal to all of the information included in one visual enrichment data and is a strict subset of the information included in the other visual enrichment data. In still other embodiments, the common information is a strict subset of both the first and the second visual enrichment data 275₁, 275₂, such that each one of them includes information that is not included in the other one.

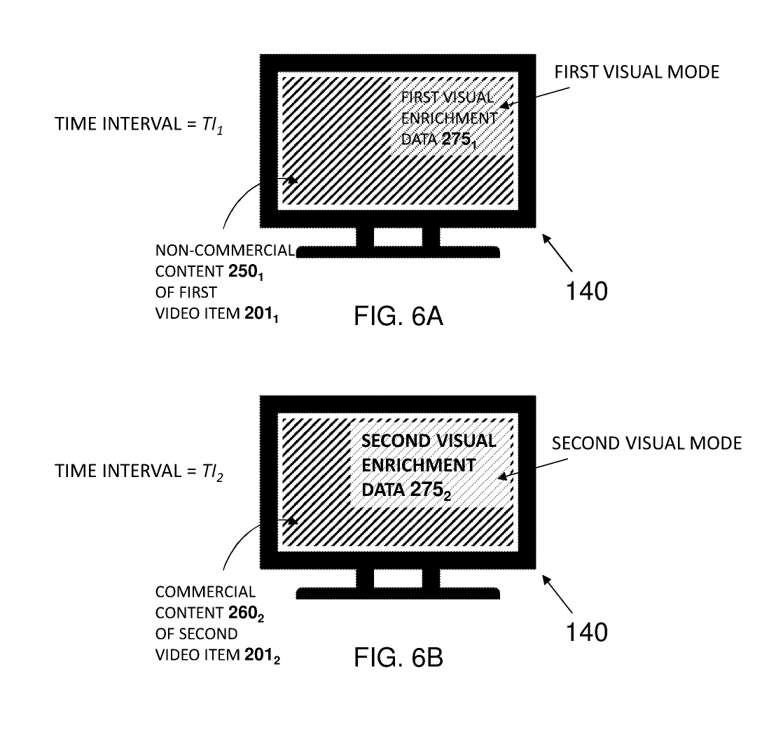

Referring now to FIG. 6A, an embodiment is illustrated that is related to the system 100₂ of FIG. 2, in which first visual enrichment data 275₁ related to the non-commercial content 250₁ of first video content item 201₁, is displayed on screen 140 (of user 90) simultaneously with non-commercial content 250₁ of first video content item 201₁, during first time interval TI₁. This simultaneous displaying can be followed, as shown in FIG. 6B, by the displaying during second time interval TI₂, of second visual enrichment data 275₂ which is related to the commercial content 260₂ of second video content item 201₂, simultaneously with the commercial content 260₂ of video content item 201₂. The various visual modes and form features, and contiguous/non-contiguous display of visual enrichment data, all as described earlier with respect to FIGS. 4A, 4B, 4C and 4D apply equally to the embodiment illustrated in FIG. 6B.

We now refer to FIG. 7 in combination with FIG. 1. The system 100₁ for distributing video content, according to some embodiments, can comprise a video-content-item distribution module 110, a visual-enrichment-data distribution module 120, one or more computer processors 145, and storage medium 130, which is a non-transitory, computer-readable medium. The one or more computer processors 145 are operative to execute program instructions 160 stored in the storage medium 130. The program instructions 160, which are represented schematically in FIG. 7, include three groups of program instructions: GPI01, GPI02 and GPI03, where each group of instructions GPI01, GPI02 and GPI03 includes program instructions for carrying out a portion of a method. The three groups comprise:
a. Group of program instructions GPI01 including program instructions for causing the video-content-item distribution module 110 to cause the displaying, on a user's screen 140, of a video content item 201 that includes non-commercial video content 250 and commercial video content 260.
b. Group of program instructions GPI02 including program instructions for causing the visual-enrichment-data distribution module 120 to cause: (A) the displaying, on the user's screen 140, of first visual enrichment data 275₁ related to the non-commercial video content 250 of the video content item 201 simultaneously with the displaying of the video content item 201, the simultaneous displaying of the first visual enrichment data 275₁ and the video content item 201 occurring during a first time interval TI₁ throughout which the displaying of the video content item 201 includes displaying non-commercial video content 250; and (B) the displaying, on the user's screen 140, of second visual enrichment data 275₂ related to the non-commercial video content 250 of the video content item 201 simultaneously with the displaying of the video content item 201, the simultaneous displaying of the second visual enrichment data 275₂ and the video content item 201 occurring during a second time interval TI₂ that is adjacent to the first time interval TI₁, throughout which second time interval TI₂ the displaying of the video content item 201 consists of displaying commercial video content 260, wherein (I) a portion of the first visual enrichment data 275₁ and a portion of the second visual enrichment data 275₂ convey the same information 280, and (II) the first visual enrichment data 275₁ and the second visual enrichment data 275₂ are of a same type of enrichment data 275, where the type of enrichment data 275 is selected from the group consisting of text, animation, video clip, still picture, and any combination of them.
c. Group of program instructions GPI03 including program instructions for causing the changing of a visual mode used for displaying visual enrichment data 275 from a first visual mode to a second visual mode, the first visual mode being different from the second visual mode, in response to an event that is a member of the event group consisting of (A) ending the first time interval TI₁ and starting the second time interval TI₂ and (B) ending the second time interval TI₂ and starting the first time interval TI₁.

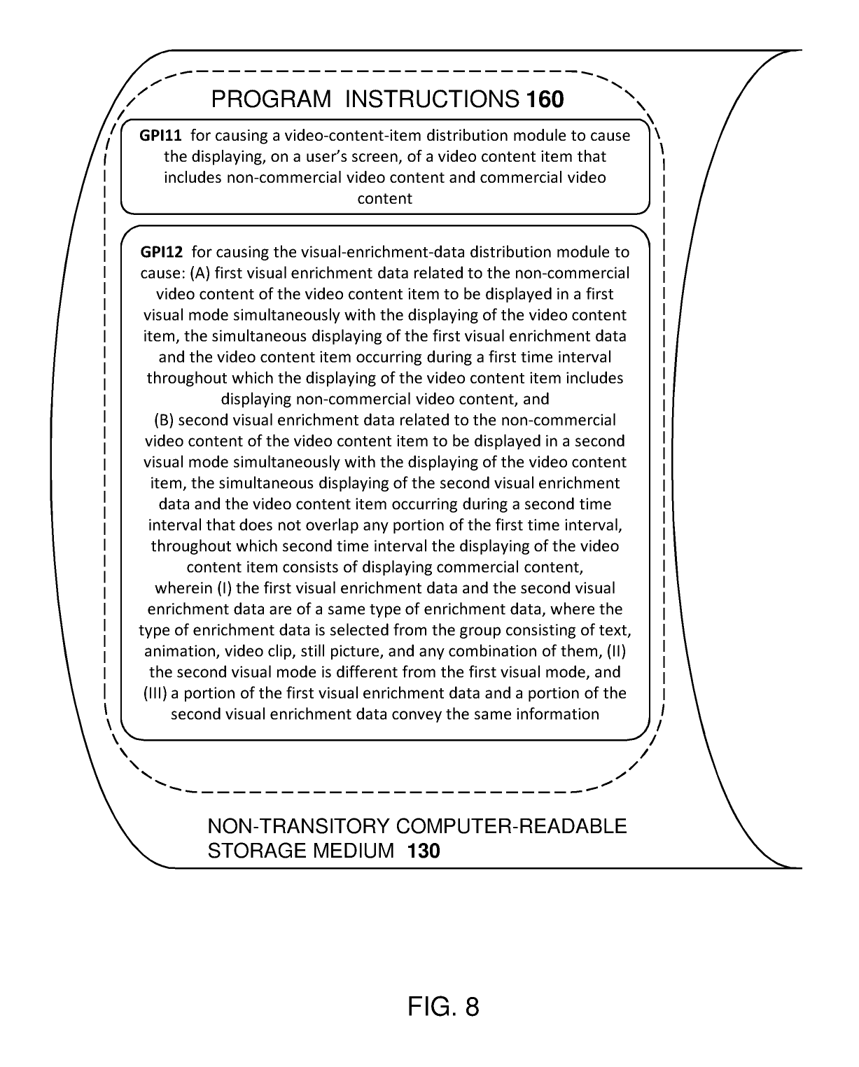

We now refer to FIG. 8 in combination with FIG. 1. The system 100₁ for distributing video content, according to some embodiments, can comprise a video-content-item distribution module 110, a visual-enrichment-data distribution module 120, one or more computer processors 145, and storage medium 130, which is a non-transitory, computer-readable medium. The one or more computer processors 145 are operative to execute program instructions 160 stored in the storage medium 130. The program instructions 160, which are represented schematically in FIG. 8, include two groups of program instructions: GPI11 and GPI12, where each group of instructions GPI11 and GPI12 includes program instructions for carrying out a portion of a method. The two groups comprise:
a. Group of program instructions GPI11 including program instructions for causing the video-content-item distribution module 110 to cause the displaying, on a user's screen 140, of a video content item 201 that includes non-commercial video content 250 and commercial video content 260.
b. Group of program instructions GPI12 including program instructions for causing the visual-enrichment-data distribution module 120 to cause: (A) first visual enrichment data 275₁ related to the non-commercial video content 250 of the video content item 201 to be displayed in a first visual mode simultaneously with the displaying of the video content item 201, the simultaneous displaying of the first visual enrichment data 275₁ and the video content item 201 occurring during a first time interval TI₁ throughout which the displaying of the video content item 201 includes displaying non-commercial video content 250, and (B) second visual enrichment data 275₂ related to the non-commercial video content 250 of the video content item 201 to be displayed in a second visual mode simultaneously with the displaying of the video content item 201, the simultaneous displaying of the second visual enrichment data 275₂ and the video content item 201 occurring during a second time interval TI₂ that does not overlap any portion of the first time interval TI₁, throughout which second time interval TI₂ the displaying of the video content item 201 consists of displaying commercial content 260, wherein (I) the first visual enrichment data 275₁ and the second visual enrichment data 275₂ are of a same type of enrichment data 275, where the type of enrichment data 275 is selected from the group consisting of text, animation, video clip, still picture and any combination of them, (II) the second visual mode is different from the first visual mode, and (III) a portion of the first visual enrichment data 275₁ and a portion of the second visual enrichment data 275₂ convey the same information 280.

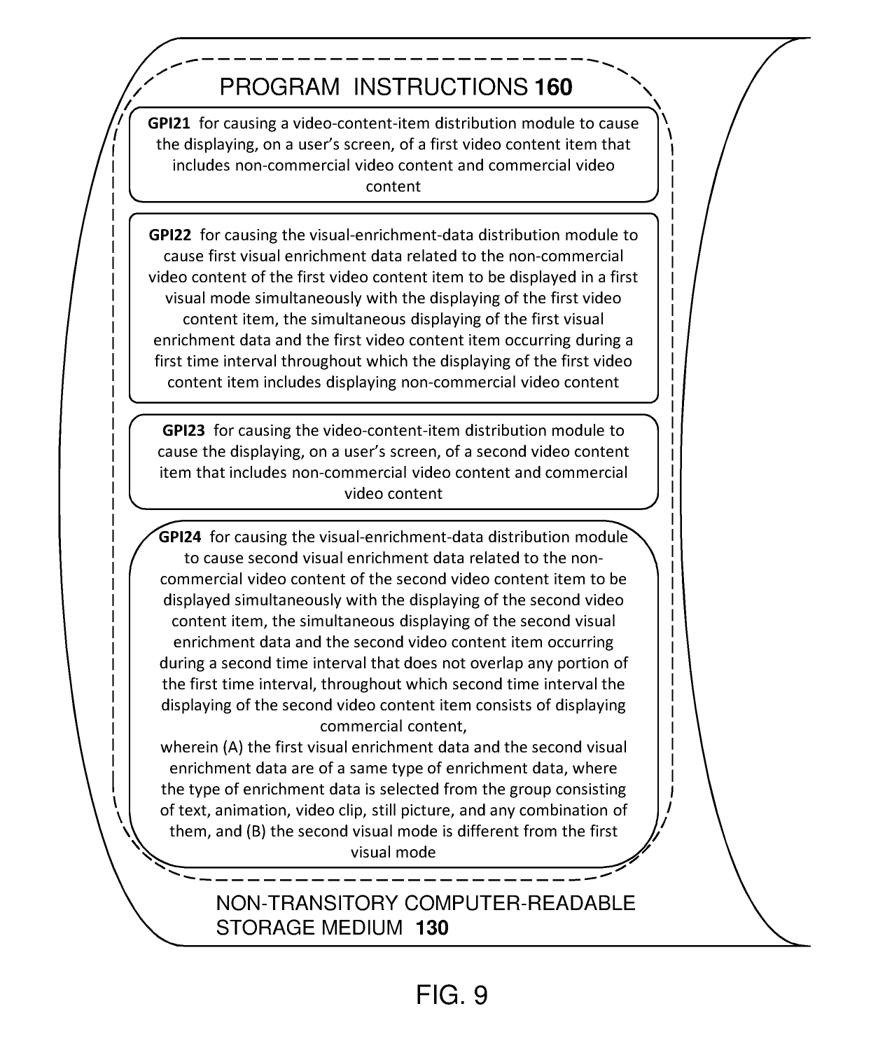

We now refer to FIG. 9 in combination with FIG. 2. The system 100₂ for distributing video content, according to some embodiments, can comprise a video-content-item distribution module 110, a visual-enrichment-data distribution module 120, one or more computer processors 145, and storage medium 130, which is a non-transitory, computer-readable medium. The one or more computer processors 145 are operative to execute program instructions 160 stored in the storage medium 130. The program instructions 160, which are represented schematically in FIG. 9, include four groups of program instructions: GPI21, GPI22, GPI23 and GPI24, where each group of instructions GPI21, GPI22, GPI23 and GPI24 includes program instructions for carrying out a portion of a method. The four groups comprise:
a. Group of program instructions GPI21 including program instructions for causing a video-content-item distribution module 110 to cause the displaying, on a user's screen 140, of a first video content item 201₁ that includes non-commercial video content 250₁ and commercial video content 260₁.
b. Group of program instructions GPI22 including program instructions for causing the visual-enrichment-data distribution module 120 to cause first visual enrichment data 275₁ related to the non-commercial video content 250₁ of the first video content item 201₁ to be displayed in a first visual mode simultaneously with the displaying of the first video content item 201₁, the simultaneous displaying of the first visual enrichment data 275₁ and the first video content item 201₁ occurring during a first time interval TI₁ throughout which the displaying of the first video content item 201₁ includes displaying non-commercial video content 260₁.
c. Group of program instructions GPI23 including program instructions for causing the video-content-item distribution module 110 to cause the displaying, on a user's screen 140, of a second video content item 201₂ that includes non-commercial video content 250₂ and commercial video content 260₂.
d. Group of program instructions GPI24 including program instructions for causing the visual-enrichment-data distribution module 120 to cause second visual enrichment data 275₂ related to the non-commercial video content 250₂ of the second video content item 201₂ to be displayed simultaneously with the displaying of the second video content item 201₂, the simultaneous displaying of the second visual enrichment data 275₂ and the second video content item 201₂ occurring during a second time interval TI₂ that does not overlap any portion of the first time interval TI₁, throughout which second time interval TI₂ the displaying of the second video content item 201₂ consists of displaying commercial content 250₂, wherein (A) the first visual enrichment data 275₁ and the second visual enrichment data 275₁ are of a same type of enrichment data 275, where the type of enrichment data 275 is selected from the group consisting of text, animation, video clip, still picture and any combination of them, and (B) the second visual mode is different from the first visual mode

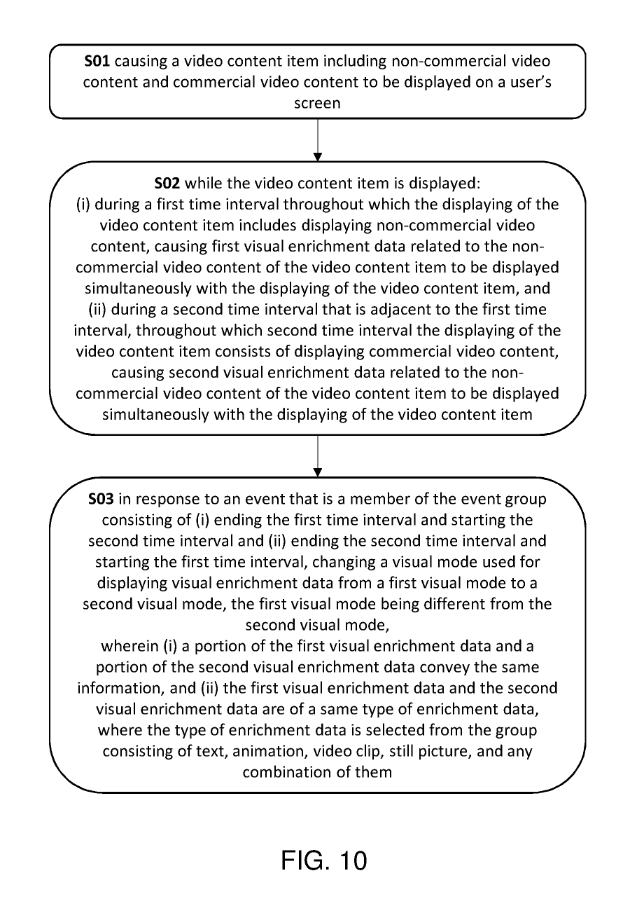

Referring now to FIG. 10, a method is disclosed for presenting, on a user's screen 140, enrichment data 275 related to a video content item 201, the video content item 201 including non-commercial video content 250 and commercial video content 260. The method, as shown in the flow chart of FIG. 10, comprises the following steps:
a. Step S01, causing a video content item 201 to be displayed on a user's screen 140.
b. Step S02, while the video content item 201 is displayed: (i) during a first time interval TI₁ throughout which the displaying of the video content item 201 includes displaying non-commercial video content 250, causing first visual enrichment data 275₁ related to the non-commercial video content 250 of the video content item 201 to be displayed simultaneously with the displaying of the video content item 201, and (ii) during a second time interval TI₂ that is adjacent to the first time interval TI₁, throughout which second time interval TI₂ the displaying of the video content item 201 consists of displaying commercial video content 260, causing second visual enrichment data 275₂ related to the non-commercial video content 250 of the video content item 201 to be displayed simultaneously with the displaying of the video content item 201.
c. Step S03, in response to an event that is a member of the event group consisting of (i) ending the first time interval TI₁ and starting the second time interval TI₁ and (ii) ending the second time interval TI₂ and starting the first time interval TI₁, changing a visual mode used for displaying visual enrichment data 275 from a first visual mode to a second visual mode, the first visual mode being different from the second visual mode, wherein (i) a portion of the first visual enrichment data 275₁ and a portion of the second visual enrichment data 275₂ convey the same information 280, and (ii) the first visual enrichment data 275₁ and the second visual enrichment data 275₂ are of a same type of enrichment data 275, where the type of enrichment data 275 is selected from the group consisting of text, animation, video clip, still picture and any combination of them.

Any of the steps in the method, and in fact any of the steps in any of the methods disclosed herein, can be implemented in any system 100 for distributing video content as disclosed herein.

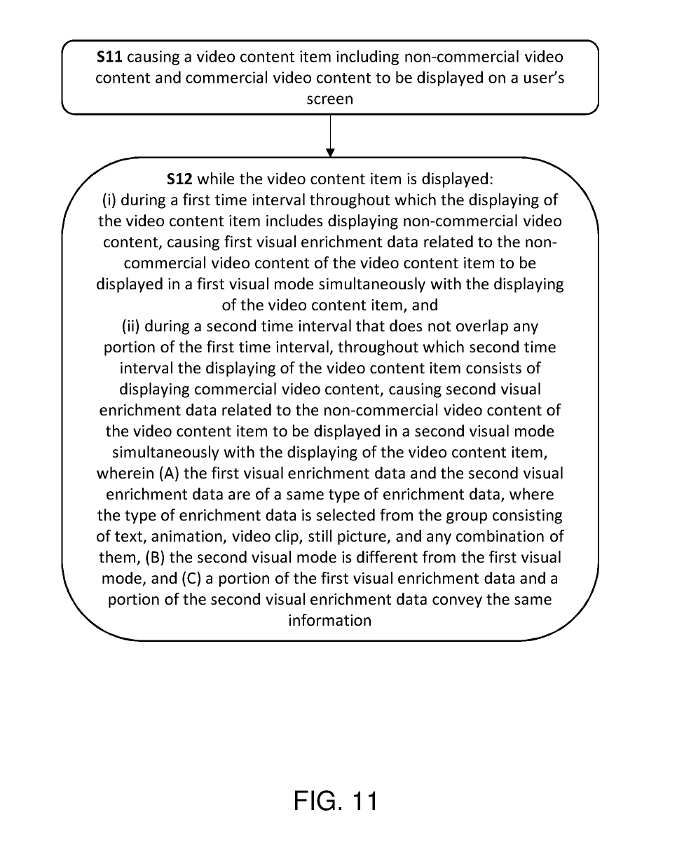

Referring now to FIG. 11, a method is disclosed for presenting, on a user's screen 140, enrichment data 275 related to a video content item 201, the video content item 201 including non-commercial video content 250 and commercial video 260 content. The method, as shown in the flow chart of FIG. 11, comprises the following steps:
a. Step S11, causing a video content item 201 to be displayed on a user's screen 140.
b. Step S12, while the video content item 201 is displayed: (i) during a first time interval TI₁ throughout which the displaying of the video content item 201 includes displaying non-commercial video content 250, causing first visual enrichment data 275₁ related to the non-commercial video content 250 of the video content item 201 to be displayed in a first visual mode simultaneously with the displaying of the video content item 201, and (ii) during a second time interval TI₂ that does not overlap any portion of the first time interval TI₁, throughout which second time interval TI₂ the displaying of the video content item 201 consists of displaying commercial video content 260, causing second visual enrichment data 275₂ related to the non-commercial video content 250 of the video content item 201 to be displayed in a second visual mode simultaneously with the displaying of the video content item 201, wherein (A) the first visual enrichment data 275₁ and the second visual enrichment data 275₂ are of a same type of enrichment data 275, where the type of enrichment data 275 is selected from the group consisting of text, animation, video clip, still picture and any combination of them, (B) the second visual mode is different from the first visual mode, and (C) a portion of the first visual enrichment data 275₁ and a portion of the second visual enrichment data 275₂ convey the same information 280.

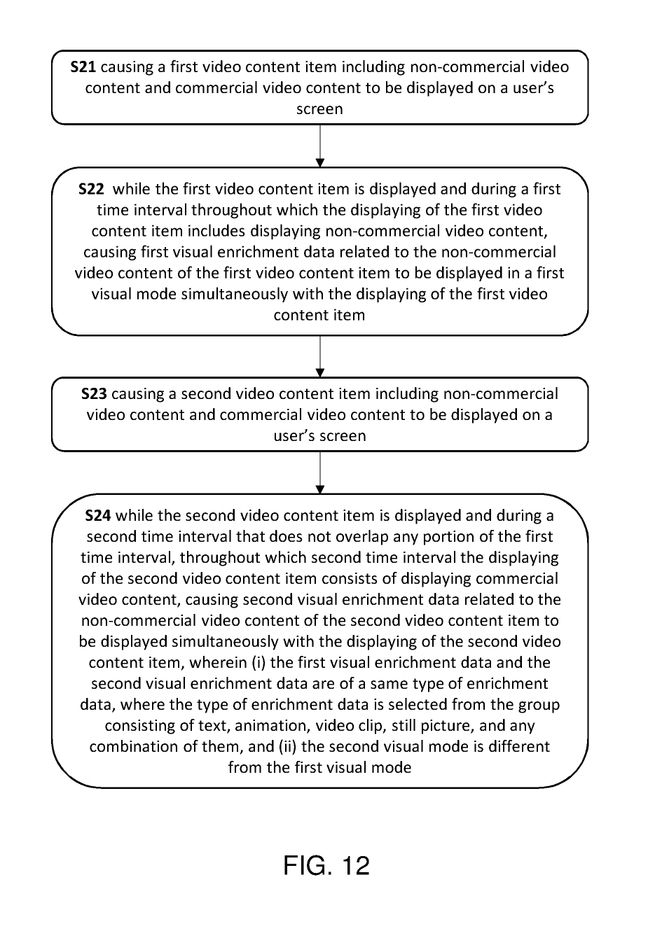

Referring now to FIG. 12, a method is disclosed for presenting, on a user's screen, enrichment data related to video content items, each video content item including non-commercial video content and commercial video content. The method, as shown in the flow chart of FIG. 12, comprises the following steps:
a. Step S21, causing a first video content item 201₁ to be displayed on the screen 140.
b. Step S22, while the first video content item 201₁ is displayed and during a first time interval TI₁ throughout which the displaying of the first video content item 201₁ includes displaying non-commercial video content 250₁, causing first visual enrichment data 275₁ related to the non-commercial video content 250₁ of the first video content item 201₁ to be displayed in a first visual mode simultaneously with the displaying of the first video content item 201₁.
c. Step S23, causing a second video content item 201₂ to be displayed on the screen 140.
d. Step S24, while the second video content item 201₂ is displayed and during a second time interval TI₂ that does not overlap any portion of the first time interval TI₁, throughout which second time interval TI₂ the displaying of the second video content item 201₂ consists of displaying commercial video content 260₂, causing second visual enrichment data 275₂ related to the non-commercial video content 260₂ of the second video content item 201₂ to be displayed simultaneously with the displaying of the second video content item 201₂, wherein (i) the first visual enrichment data 275₂ and the second visual enrichment data 275₂ are of a same type of enrichment data 275, where the type of enrichment data 275 is selected from the group consisting of text, animation, video clip, still picture and any combination of them, and (ii) the second visual mode is different from the first visual mode.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

### Definitions

This disclosure should be interpreted according to the definitions below.

In case of a contradiction between the definitions in this Definitions section and other sections of this disclosure, this section should prevail.

In case of a contradiction between the definitions in this section and a definition or a description in any other document, including in another document included in this disclosure by reference, this section should prevail, even if the definition or the description in the other document is commonly accepted by a person of ordinary skill in the art.
1. “media content item”—a standalone unit of media content that can be referred to and identified by a single reference and can be played independently of other content. For example, a movie, a TV program, an episode of a TV series, a video clip, an animation, an audio clip, or a still image.
   A media content item may include only non-commercial media content, or alternatively it may include both non-commercial media content and commercial media content. In the second case, the commercial media content may be an integral part of the media content item, or it may be dynamically inserted into the media content item on its way from its provider to a visual/audio output device which plays it. Thus, a media content item may include different commercial content in different events of being played.
2. “video content item”—a media content item that contains a visual track viewable on a screen. A video content item may or may not additionally contain an audio track. A still image is a special case of a video content item.
   A video content item may include only non-commercial video content, or alternatively it may include both non-commercial video content and commercial video content.
3. “audio content item”—a media content item that contains only an audio track hearable using a speaker or headphones, but does not contain a visual track.
   An audio content item may include only non-commercial audio content, or alternatively it may include both non-commercial audio content and commercial audio content.
4. “audio” and “aural” are used as synonyms herein.
5. “video” and “visual” are used as synonyms herein.
6. “audio channel” and “audio track” are used as synonyms herein. Both refer to an audio component of a media content item.
7. “video channel” and “video track” are used as synonyms herein. Both refer to a video component of a media content item. A still image is a special case of video track.
8. “commercial media content”—Media content that is an advertisement intended for promoting or selling a product, a service or an idea.
9. “commercial video content”—Video content that is an advertisement intended for promoting or selling a product, a service or an idea.
10. “commercial audio content”—Audio content that is an advertisement intended for promoting or selling a product, a service or an idea.
11. “true media content” or “non-commercial media content”—Media content that is not commercial media content.
12. “true video content” or “non-commercial video content”—Video content that is not commercial video content.
13. “true audio content” or “non-commercial audio content”—Audio content that is not commercial audio content.
14. “enrichment data of a media content item”—Data that is related in some way to the media content item. For example, a table of sport statistics related to a team participating in a sporting event that is being shown in the media content item, a still picture of a person which is shown or mentioned in the media content item, an audio clip explaining a term mentioned in the media content item, and a video clip providing information about an actor appearing in the media content item. Any combination of different types of enrichment data of a media content item is also enrichment data of the media content item.
15. “visual enrichment data of a media content item”—Enrichment data of the media content item that includes a visual channel.
16. “a type of enrichment data”—An attribute of enrichment data that is related to its form. The type is selected from the group consisting of text, animation, video clip, still picture, audio clip and any combination of them. For visual enrichment data, the type is selected from the group consisting of text, animation, video clip, still picture and any combination of them.
17. “a visual mode of displaying enrichment data”—a mode of displaying the enrichment data that affects one or more visual characteristics of the displayed enrichment data.
18. “a visual characteristic of displayed enrichment data”—An attribute of the visual appearance of the displayed enrichment data. Examples of a visual characteristics of displayed enrichment data are size, level of detail, transparency, color and screen location.
19. “a first time interval immediately follows a second time interval”—The first time interval is adjacent to the second time interval on the time axis, where the first time interval starts at the time the second time interval ends.
20. “media playing device”—a device that is capable of playing a media content item. For example, an audio-only player that is capable of playing an audio content item, a video-only player that is capable of playing a video content item, a combined video/audio player that is capable of playing both the video channel and the audio channel of a media content item in parallel.
21. “VOD” or “Video On Demand”—A service which allows users to select and watch video content items such as movies and TV shows when they choose to, rather than having to watch at a specific broadcast time.
22. “playing media content”—outputting at least one of a video channel and an audio channel of the media content to a visual output device (for example a TV screen) or to an audio output device (for example a speaker or headphones). If the media content is a still image, then playing it means outputting the still image to a visual output device. If the media content is video content that has both a video channel and an audio channel, then playing it means outputting both the video channel and the audio channel to a visual output device and to an audio output device, respectively.
23. “displaying media content”—outputting a video channel of the media content to a visual output device (for example a TV screen). If the media content is a still image, then displaying it means outputting the still image to a visual output device.
24. “displaying enrichment data over a video content item” or “displaying enrichment data on top of a video content item”—Displaying the enrichment data on an area of the screen that, at least when no enrichment data is displayed, is used for displaying at least a portion of the video content item. The displaying of the enrichment data may be opaque or partially transparent, resulting in the at least a portion of the video content item being fully or partially hidden by the displayed enrichment data, respectively.
25. “displaying enrichment data side by side with a video content item”—Displaying the enrichment data on an area of the screen that, when the enrichment data is displayed, is not used for displaying any portion of the video content item. Consequently, no portion of the video content item is being fully or partially hidden by the displayed enrichment data.
26. “a portion of X”—A subset of X. Note that the portion or the subset may be equal to all of X. In other words, “X is a portion of X” and “X is a subset of X” are always correct statements.
27. “a strict portion of X” or “a strict subset of X”—A portion/subset that is not equal to X but is smaller than X.
28. “enrichment data A and enrichment data B convey the same information”—A user watching enrichment data A receives the same information as a user watching enrichment data B.

1. A method for presenting, on a user's screen, enrichment data related to a video content item, the video content item including non-commercial video content and commercial video content, the method comprising:
a. causing the video content item to be displayed on the screen;
b. while the video content item is displayed:
i. during a first time interval throughout which the displaying of the video content item includes displaying non-commercial video content, causing first visual enrichment data related to the non-commercial video content of the video content item to be displayed simultaneously with the displaying of the video content item, and
ii. during a second time interval that is adjacent to the first time interval, throughout which second time interval the displaying of the video content item consists of displaying commercial video content, causing second visual enrichment data related to the non-commercial video content of the video content item to be displayed simultaneously with the displaying of the video content item; and
c. in response to an event that is a member of the event group consisting of (i) ending the first time interval and starting the second time interval and (ii) ending the second time interval and starting the first time interval, changing a visual mode used for displaying visual enrichment data from a first visual mode to a second visual mode, the first visual mode being different from the second visual mode,
wherein (i) a portion of the first visual enrichment data and a portion of the second visual enrichment data convey the same information, and (ii) the first visual enrichment data and the second visual enrichment data are of a same type of enrichment data, where the type of enrichment data is selected from the group consisting of text, animation, video clip, still picture and any combination of them.

2. The method of claim 1, wherein the second visual enrichment data and the commercial video content are displayed simultaneously, without either one obscuring any portion of the other, during at least a portion of the second time interval.

3. The method of claim 1, wherein the second visual enrichment data is displayed at least partly superimposed over the commercial video content during at least a portion of the second time interval.

4. The method of claim 1, wherein the portion of the first visual enrichment data and the portion of the second visual enrichment data are displayed so that they differ in at least one visual characteristic.

5. The method of claim 1, wherein the portion of the first visual enrichment data and the portion of the second visual enrichment data are displayed on the screen in different sizes.

6. The method of claim 1, wherein the portion of the first visual enrichment data and the portion of the second visual enrichment data are displayed on the screen in different levels of detail.

7. The method of claim 1, wherein the portion of the first visual enrichment data and the portion of the second visual enrichment data are displayed on the screen in different levels of transparency.

8. The method of claim 1, wherein the portion of the first visual enrichment data and the portion of the second visual enrichment data are displayed on the screen in different colors.

9. The method of claim 1, wherein the portion of the first visual enrichment data and the portion of the second visual enrichment data are displayed in different locations on the screen.

10. The method of claim 1, wherein the portion of the first visual enrichment data and the portion of the second visual enrichment data contain text in the same language, and the text in the portion of the first visual enrichment data and the text in the portion of the second visual enrichment data are displayed on the screen in different fonts.

11. The method of claim 10, wherein the different fonts differ in at least one attribute selected from the group consisting of font family, font style and font size.

12. A method for presenting, on a user's screen, enrichment data related to a video content item, the video content item including non-commercial video content and commercial video content, the method comprising:
a. causing the video content item to be displayed on the screen; and
b. while the video content item is displayed:
i. during a first time interval throughout which the displaying of the video content item includes displaying non-commercial video content, causing first visual enrichment data related to the non-commercial video content of the video content item to be displayed in a first visual mode simultaneously with the displaying of the video content item, and
ii. during a second time interval that does not overlap any portion of the first time interval, throughout which second time interval the displaying of the video content item consists of displaying commercial video content, causing second visual enrichment data related to the non-commercial video content of the video content item to be displayed in a second visual mode simultaneously with the displaying of the video content item,
wherein (i) the first visual enrichment data and the second visual enrichment data are of a same type of enrichment data, where the type of enrichment data is selected from the group consisting of text, animation, video clip, still picture and any combination of them, (ii) the second visual mode is different from the first visual mode, and (iii) a portion of the first visual enrichment data and a portion of the second visual enrichment data convey the same information.

13. The method of claim 12, wherein the portion of the first visual enrichment data and the portion of the second visual enrichment data are displayed so that they differ in at least one visual characteristic.

14. The method of claim 12, wherein the portion of the first visual enrichment data and the portion of the second visual enrichment data are displayed on the screen in different levels of detail.

15. The method of claim 12, wherein the portion of the first visual enrichment data and the portion of the second visual enrichment data are displayed on the screen in different levels of transparency.

16. The method of claim 12, wherein the portion of the first visual enrichment data and the portion of the second visual enrichment data contain text in the same language, and the text in the portion of the first visual enrichment data and the text in the portion of the second visual enrichment data are displayed on the screen in different fonts.

17. The method of claim 16, wherein the different fonts differ in at least one attribute selected from the group consisting of font family, font style and font size.

18. A method for presenting, on a user's screen, enrichment data related to video content items, each video content item including non-commercial video content and commercial video content, the method comprising:
a. causing a first video content item to be displayed on the screen;
b. while the first video content item is displayed and during a first time interval throughout which the displaying of the first video content item includes displaying non-commercial video content, causing first visual enrichment data related to the non-commercial video content of the first video content item to be displayed in a first visual mode simultaneously with the displaying of the first video content item;
c. causing a second video content item to be displayed on the screen;
d. while the second video content item is displayed and during a second time interval that does not overlap any portion of the first time interval, throughout which second time interval the displaying of the second video content item consists of displaying commercial video content, causing second visual enrichment data related to the non-commercial video content of the second video content item to be displayed simultaneously with the displaying of the second video content item,
wherein (i) the first visual enrichment data and the second visual enrichment data are of a same type of enrichment data, where the type of enrichment data is selected from the group consisting of text, animation, video clip, still picture and any combination of them, and (ii) the second visual mode is different from the first visual mode.

19. The method of claim 18, wherein a portion of the first visual enrichment data and a portion of the second visual enrichment data convey the same information.

20. The method of claim 18, wherein the portion of the first visual enrichment data and the portion of the second visual enrichment data are displayed so that they differ in at least one visual characteristic.
